(19) United States
(12) Patent Application Publication
(10) Pub. No.: US 2006/0133890 A1
(43) Pub. Date: Jun. 22, 2006

(54) Connection device of adjustable length between two parts

(75) Inventors: Gerard Etoile, Nemours (FR); Michel Andre Bouru, Montereau Sur Le Jard (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SNECMA, Paris (FR)

(21) Appl. No.: 11/294,551

(22) Filed: Dec. 6, 2005

(30) Foreign Application Priority Data
Dec. 16, 2004 (FR) 0413383

(51) Int. Cl. F16C 11/00

(52) U.S. Cl. 403/122

(57) ABSTRACT

A rigid connection of constant length between two moving parts is made adjustable by a device comprising a link installed between the two parts and hinged by a clevis to one of the parts via a hinge pin that is provided with an eccentric portion of angular position that is adjustable by means of two corrugated washers.

The invention relates to a connection device between two parts, typically between a control member and a controlled part. More particularly, the invention relates to means for precisely adjusting the length of a hinged rigid connection constituting a link that is installed between said two parts.

### BACKGROUND OF THE INVENTION

In numerous mechanical systems, there arises a problem of adjusting the length of a link or the like (providing a hinged rigid connection between two parts), in particular because of tolerances involved in manufacturing and assembling the parts.

Usually, such adjustment is implemented by integrating a kind of turnbuckle in the link. The link is thus complex and made up of a certain number of components.

### OBJECTS AND SUMMARY OF THE INVENTION

The invention proposes a solution that presents several advantages:

the link comprises a single piece without any turnbuckle;

adjustment can be very accurate;

the link is strong and relatively insensitive to the forces to be transmitted.

The idea on which the invention is based consists in using a hinge with an adjustable eccentric, at at least one of the ends of the link.

More precisely, the invention provides a device for making a connection between two parts, the device being of the type comprising a hinged link extending between said parts, wherein at least one of the ends of said link includes a link head hinged in a clevis to the corresponding part, and wherein a hinge pin mounted between said clevis and said link is provided with an eccentric portion of adjustable angular position that is stabilized by co-operation between two radially-corrugated washers secured respectively to said clevis and to said pin.

Said eccentric portion may form part of the pin itself, or it may be constituted at least in part by an eccentric bushing carried by the pin.

Advantageously, the pin carries a ball on which the above-mentioned link head pivots.

In a first possible embodiment, a first corrugated washer includes a lateral lug extending parallel to the axial direction of the pin, while the clevis includes externally at least one positioning slot suitable for receiving the lateral lug.

Advantageously, said clevis has a plurality of positioning slots that are angularly offset by a predetermined angle so as to increase the number of possible adjustment positions. For example, said slots may be offset from one another by an integer number of the corrugations as defined on said corrugated washer plus a fraction of the angular extent of one washer corrugation. If the clevis has n slots, then that fraction is advantageously equal to:
1/n

In certain embodiments, said eccentric portion is localized between the two plates of the clevis and carries the ball. Otherwise, in other embodiments, said eccentric portion comprises two segments received respectively in bores formed in the plates of said clevis. The two segments can be circumferentially held in register relative to each other by any suitable simple means so as to present the same eccentricity relative to the clevis.

The invention is particularly applicable to any kind of mechanical transmission. In particular, in the field of turbomachines, and more particularly in the field of aero-engine compressors, it is conventional to control the pitch of stator vanes in at least one stage of said compressor by means of an actuator ring surrounding its casing, the ring being mechanically coupled to a plurality of vane pivots that project from the compressor. The ring itself is actuated by drive means, e.g. an actuator, acting via a bell-crank mechanism.

The invention may advantageously be applied to a link for providing for transmission between drive means (more precisely the bell-crank) and the actuator ring.

### BRIEF DESCRIPTION OF THE DRAWINGS

The invention can be better understood and other advantages thereof appear better in the light of the following description of several embodiments of mechanical connections implementing the principle of the invention, given purely by way of example, and made with reference to the accompanying drawings, in which:

FIG. 1 is a detail view in perspective showing the general arrangement of a connection device provided with an adjustment system in accordance with the invention installed between a one-piece link and a clevis provided on the actuator ring of a system for controlling the positioning of variable-pitch stator vanes in a compressor;

FIG. 2 is an exploded perspective view partially in section and on a larger scale showing a detail of FIG. 1;

FIG. 3 is a detail view analogous to FIG. 2 showing a variant;

FIG. 4 is a view analogous to FIG. 2 showing another variant;

FIG. 5 is a section view on a plane containing the pin axis, and showing another variant;

FIG. 5A is a detail view showing a part of the FIG. 5 mechanism;

FIG. 6 is a section view on a plane containing the pin axis, showing another variant; and

FIG. 6A is a detail view of a part of the FIG. 6 mechanism.

### MORE DETAILED DESCRIPTION

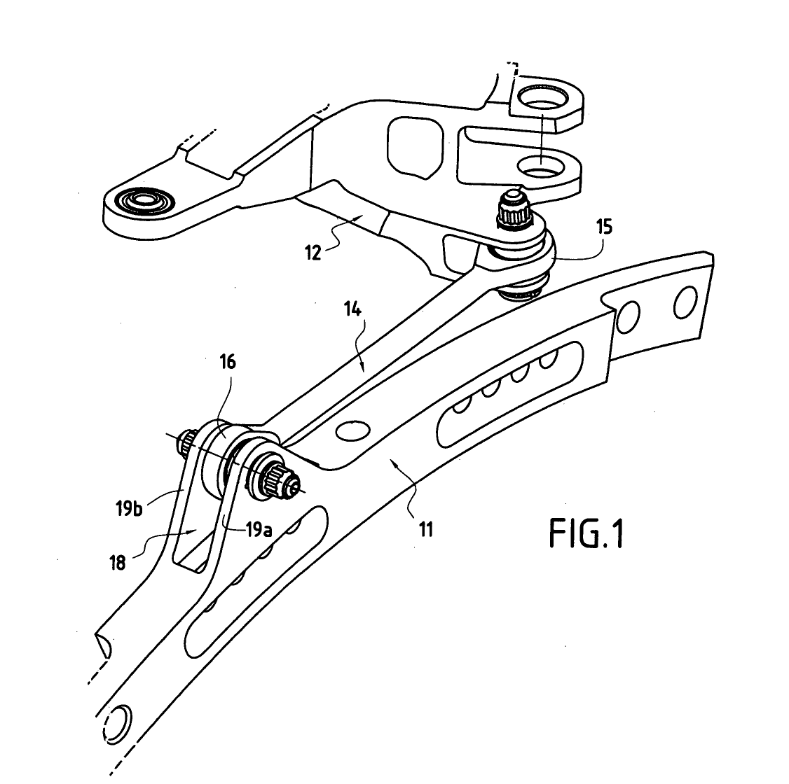

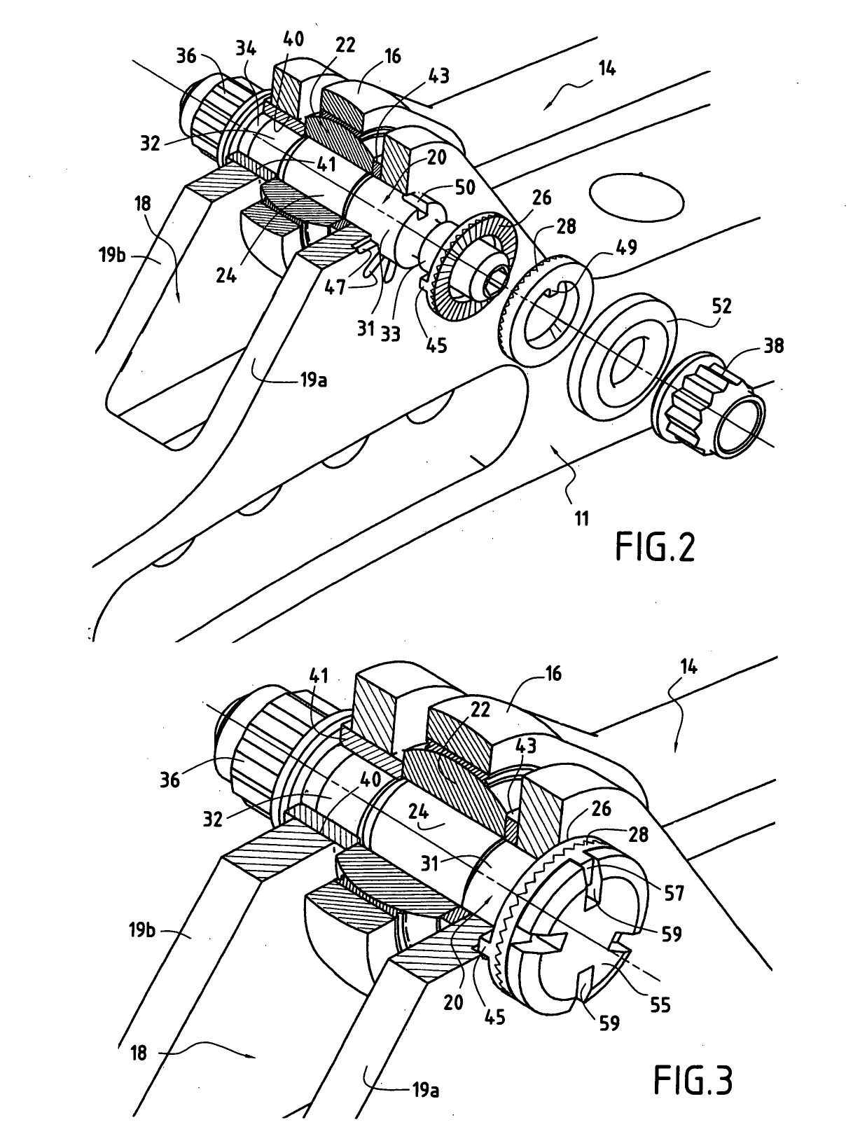

As mentioned above, FIG. 1 shows an actuator ring 11 arranged on the outside of a turbomachine casing (not shown) for controlling the pitch of a plurality of stator vanes. The ring is connected to each vane pivot that projects from the casing via a respective link (not shown). The movement of the ring as a whole is controlled by an actuator actuating a pivot part 12 referred to as a “bell-crank”. This pivot part is connected mechanically to the actuator ring via a connection device in accordance with the invention. This connection device comprises a one-piece link 14. One link head 15 is hinged to the bell-crank. The other link head 16 is hinged via a clevis to the ring 11. The detail of this hinge which includes the essential elements of the invention can be seen in FIG. 2. Said clevis comprises two parallel side plates 19a and 19b defined on the outside of the actuator ring 11. A hinge pin 20 is mounted between the clevis 18 and the link 14. More precisely, as shown, said pin carries a ball 22 on which the link head pivots. The pin is provided with an eccentric portion 24 of adjustable angular position that is stabilized by co-operation between two radially-corrugated washers 26 and 28 secured respectively to said clevis 18 and to said pin 20. In the embodiment of FIG. 2, the eccentric portion 24 is formed on the pin itself, and it is this eccentric portion situated between the two plates 19a and 19b of the clevis that carries the ball 22. The other two segments 31 and 32 of the pin, on either side of the central eccentric portion are themselves on a common axis. They extend out from the clevis via threaded segments 33 and 34. The threaded segment 34 receives a nut 36. The other threaded segment 33 similarly receives another nut 38, with the corrugated washers 26 and 28 being interposed between them. The plate 19b of the clevis includes a hole 40 for passing the pin that is of greater diameter than is the pin itself so as to allow the parts to be mounted in the clevis. A cylindrical compensation ring 41 is mounted between the plate 19b and the segment 32 passing therethrough. In addition, the compensation ring 41 is mounted to bear against both the nut and the ball. As can be seen in FIG. 2, the length of the compensation ring is such that the clamping force is taken up solely by the opposite plate 19a of the clevis. Nevertheless, a positioning washer 43 is interposed between said opposite plate and the ball 22 in order to ensure that it is properly centered between the two plates of the clevis. This configuration avoids stresses tending to move the two plates towards each other.

Each corrugated washer has a plurality of teeth of V-shaped profile extending radially and engaging between the teeth of the other corrugated washer.

For the configuration shown in FIG. 2, there can be seen a first corrugated washer 26 with a lateral lug 45 extending parallel to the axial direction of the pin. Furthermore, the plate 19a of the clevis includes externally at least one positioning slot 47 suitable for receiving the lateral lug 45. In this example, the plate of the clevis includes three positioning slots 47 that are angularly offset by a determined angle, as mentioned above, so as to increase the number of possible adjustment positions. More precisely, relative to the angular pitch defined by the corrugations in the washers 26 and 28, the three positioning slots can be offset angularly by an arbitrary whole number of angular pitch steps, plus one-third of said angular pitch. This provides the ability to adjust position more finely than is possible by the angular pitch defined by the shape of the corrugated washers, specifically adjustment can be to within one-third of said angular pitch.

Furthermore, a second corrugated washer 28 has a radial lug 49 extending inwards, and the pin 20 has a groove 50 parallel to its axis in the portion of the pin that projects outside the plate 19a. The radial lug 49 engages in this groove. Thus, the corrugated washer 26 is secured to the clevis while the corrugated washer 28 is secured to the pin. A hollow washer 52 partially covering the stack of corrugated washers is interposed between the corrugated washer 28 and the nut 38.

In the embodiment of FIG. 3, structural elements that are analogous to those shown in FIG. 2 are given the same numerical references and they are not described again. This embodiment is remarkable in that one of the ends of the pin 20 includes a head 55 (instead of a threaded segment) against which said second corrugated washer 28 comes to bear. The second washer has a lateral lug 57 extending parallel to the axial direction of the pin, and the head 55 includes at least one positioning slot 59 suitable for receiving said lateral lug.

To increase the number of adjustment positions, as in the above-described embodiment, it is possible to provide a plurality of slots in the plate 19a to hold the corrugated washer in a plurality of possible positions, however it is also possible, as shown, to provide a plurality of positioning slots 59 in the head itself, which slots are angularly offset by a determined angle, with the offset angles being calculated in the same manner as mentioned above. In the embodiment described, four positioning slots are provided in the head itself.

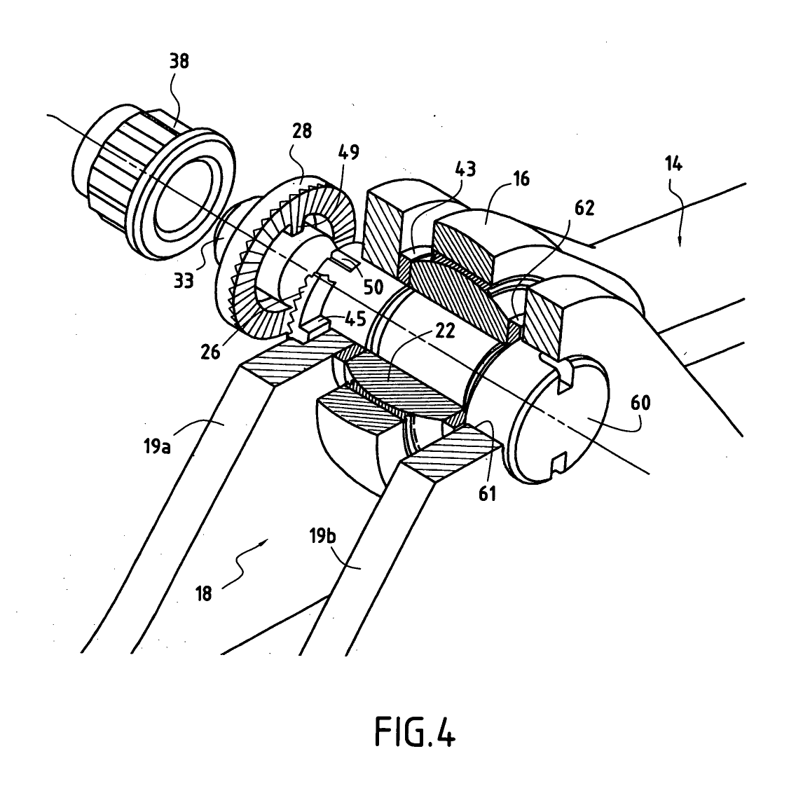

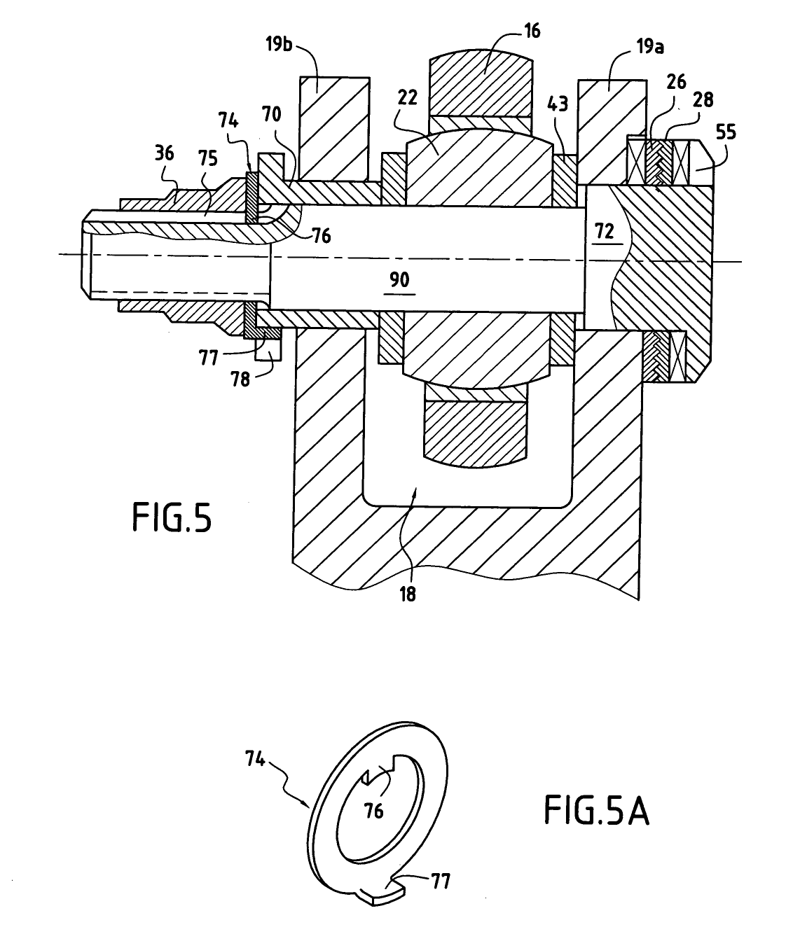

In the embodiment of FIG. 4, the configuration of corrugated washers is similar to that shown in FIG. 2. However, beside the other plate 19b of the clevis 18, the pin has a cylindrical head 60 of larger diameter (thus making assembly possible) and this head fits in a corresponding bore 61 in the plate 19b. It bears against the ball via a centering washer 62. Thus, the clamping forces are taken up exclusively by the other plate 19a beside the corrugated washers.

In the embodiments described below, the eccentric portion is no longer at the center of the clevis 18, but is combined with the two segments 31 and 32 engaged in the plates 19a and 19b thereof. In other words, the eccentric portion comprises two segments received in bores formed in the plates of the clevis. In the embodiment of FIG. 5, one of the segments is implemented by an eccentric bushing 70 mounted on the pin 20, while the other segment is constituted by an eccentric portion 72 of the pin itself, adjacent to an outer head 55 thereof. The corrugated washers 26 and 28 are arranged between said head and the plate 19a, as in the embodiment of FIG. 3. The two segments are located circumferentially in register relative to each other so as to present the same eccentricity relative to the clevis. This is achieved by means of a synchronizing washer 74 interposed between the nut 36 and the end of the eccentric bushing 70. This washer, shown in greater detail in FIG. 5A, has a radial tab 76 extending inwards and engaged in a longitudinal groove 75 formed in the threaded segment of the pin. It also has a longitudinally-extending tab 77 engaged in a slot 78 in the bushing 70. As before, the bushing is of a length that is sufficient to take up the clamping force on either side of the plate 19a.

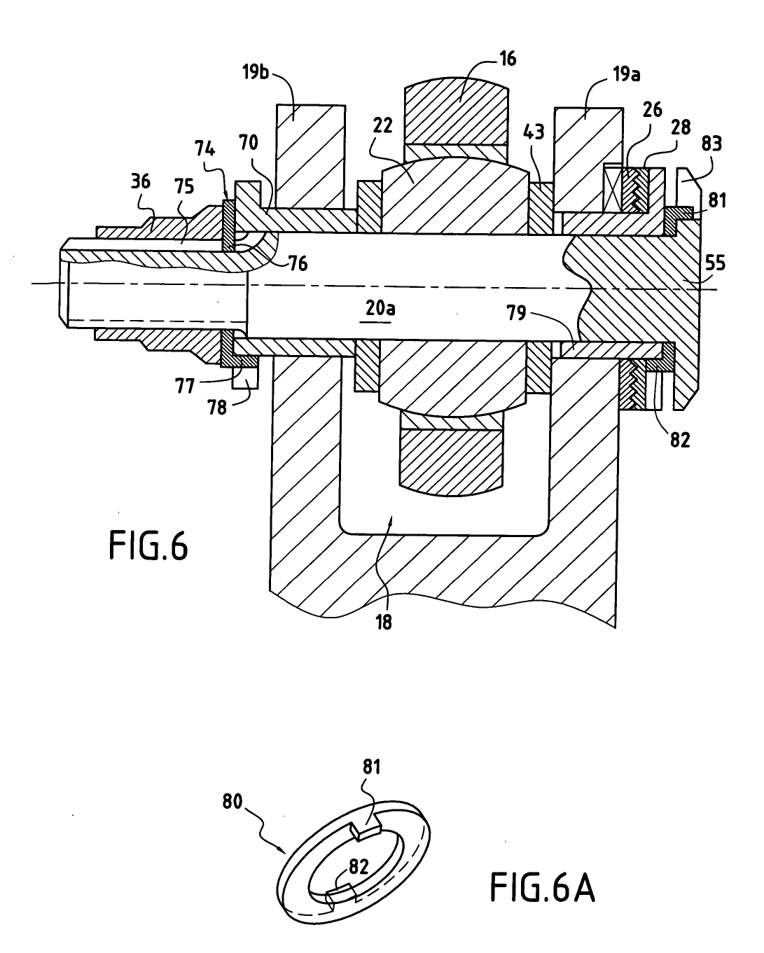

In the embodiment of FIG. 6, two opposite eccentric bushings 70 and 79 are provided mounted on a cylindrical pin 20a having a head 55 at one of its ends. Beside the nut 36, assembly is identical to that shown in FIG. 5 using the same type of synchronization washer 74. Beside the head 55, another synchronization washer 80 is interposed between the head 55 and the eccentric bushing 79. This synchronization washer is of the shape shown in greater detail in FIG. 6A. It includes two axially-extending tabs 81 and 82. One of the tabs is engaged in a slot in the bushing 80, while the other tab that extends in the opposite direction is engaged in a slot 83 in the head 55 of the cylindrical pin.

What is claimed is:

1. A device for making a connection between two parts, the device being of the type comprising a hinged link extending between said parts, wherein at least one of the ends of said link includes a link head hinged in a clevis to the corresponding part, and wherein a hinge pin mounted between said clevis and said link is provided with an eccentric portion of adjustable angular position that is stabilized by co-operation between two radially-corrugated washers secured respectively to said clevis and to said pin.

2. A device according to claim 1, wherein said pin carries a ball on which the above-mentioned link head pivots.

3. A device according to claim 1, wherein a first corrugated washer includes a lateral lug extending parallel to the axial direction of said pin, and wherein said clevis includes externally at least one positioning slot suitable for receiving said lateral lug.

4. A device according to claim 3, wherein said clevis includes a plurality of positioning slots that are angularly offset by a predetermined angle so as to increase the number of possible adjustment positions.

5. A device according to claim 1, wherein a second corrugated washer includes a radial lug, and wherein said pin includes a groove parallel to its axis, in which said radial lug is engaged.

6. A device according to claim 1, wherein one of the ends of said pin includes a head against which a second corrugated washer bears, wherein said second corrugated washer includes a lateral lug extending parallel to the axial direction of said pin, and wherein said head includes at least one positioning slot suitable for receiving said lateral lug.

7. A device according to claim 6, wherein said head has a plurality of positioning slots angularly offset by a determined angle in order to increase the number of possible adjustment positions.

8. A device according to claim 2, wherein said eccentric portion is situated on the pin itself, and wherein it carries said ball.

9. A device according to claim 8, wherein one of the plates of said clevis includes a hole for passing said pin that is larger in diameter than said pin, wherein a cylindrical compensation ring is mounted between said plate and said pin, and wherein said compensation ring is mounted between said ball and a nut screwed onto a threaded end of said pin, the length of said ring being such that the clamping force is taken up exclusively on the other plate of said clevis.

10. A device according to claim 8, wherein said pin has a cylindrical head of greater diameter that is fitted in a corresponding bore of one of the plates and that bears against said ball in such a manner that the clamping force is taken up exclusively by the other plate.

11. A device according to claim 2, wherein said eccentric portion comprises two segments received respectively in bores formed in the plates of said clevis.

12. A device according to claim 11, wherein the two segments are held circumferentially in position relative to each other so as to present the same eccentricity.

13. A device according to claim 11, wherein one of said segments is constituted by an eccentric bushing mounted on the pin, and the other by an eccentric portion of the pin itself.

14. A device according to claim 11, wherein each segment is constituted by an eccentric bushing mounted on said pin.
